(19) United States
(12) Patent Application Publication
(10) Pub. No.: US 2022/0342410 A1
(43) Pub. Date: Oct. 27, 2022

(54) INFORMATION PROCESSING APPARATUS

(71) Applicant: Mitsubishi Electric Corporation, Tokyo (JP)

(72) Inventors: Koji NAGAMATSU, Tokyo (JP); Hidematsu HAYASHI, Tokyo (JP); Taku SHIGIHARA, Tokyo (JP); Hideaki TASHIRO, Tokyo (JP)

(73) Assignee: Mitsubishi Electric Corporation, Tokyo (JP)

(21) Appl. No.: 17/639,906

(22) PCT Filed: Nov. 5, 2019
(86) PCT No.: PCT/JP2019/043271

§ 371 Date: Mar. 3, 2022

(51) Int. Cl. G05B 23/02

(52) U.S. Cl. CPC G05B 23/0283

(57) ABSTRACT

An information processing apparatus includes: an algorithm block unit that stores one or more algorithms that perform information processing related to predictive maintenance of an industrial machine and a component of the industrial machine; a parameter block unit that stores one or more parameters applicable to an algorithm stored in the algorithm block unit; a diagnosis unit that performs information processing, using an algorithm selected by a user among the algorithms stored in the algorithm block unit, and performs diagnosis of the industrial machine and the component of the industrial machine; and a first interface unit that reads, from the parameter block unit, a parameter associated with the algorithm selected by the user, and passes the parameter to the algorithm selected by the user.

### FIELD

The present invention relates to an information processing apparatus that performs information processing related to predictive maintenance of industrial machines and components of the industrial machines.

### BACKGROUND

Time-based maintenance based on information such as use time and the number of uses is conventionally performed on industrial machines. For the time-based maintenance, the component is replaced in order to prevent an occurrence of a defect in the industrial machine, at a time when a use time or the number of uses reaches a predetermined value. Unfortunately, service life varies among the components, and the maintenance cost increases because of excessive maintenance work such as replacing components earlier than the ends of their service lives. Further, the production stops because of sudden failures of the components. To solve these problems, there is the need to optimize the maintenance work by condition-based maintenance based on sensing of industrial machines.

Generally, performing predictive maintenance requires sensing according to machine components and a machine operation pattern, and dedicated analysis processing, and it has been necessary to develop individual diagnosis functions corresponding to various types of information such as a component manufacturer, a model, and an operation pattern.

Patent Literature 1 describes an invention that searches for a necessary test procedure from a plurality of prepared test procedures, using search keys such as a machine manufacturer, a machine name, a year of machine manufacture, and signs found at a time of use of machines. The invention of Patent Literature 1 collects and analyzes necessary data in accordance with a test procedure which a user selects from the thus searched test procedures.

### CITATION LIST

### Patent Literature

Patent Literature 1: Japanese Patent Application Laid-open No. 2001-202125

### SUMMARY

### Technical Problem

Some industrial machine is made up of a mixture of a plurality of components of different manufacturers. In addition, a typical production factory having industrial machines introduced thereinto includes various types of industrial machines of different manufacturers. For this reason, individual analysis processing by industrial machine and individual analysis processing by industrial machine component are required in order to perform predictive maintenance of each industrial machine in the production factory. Each piece of analysis processing is performed by an algorithm created on the basis of, for example, specifications and functions of the corresponding industrial machine or component. Each algorithm and a parameter which each algorithm uses in performing the analysis processing are individually created by industrial machine or component. There is one possible case where a manufacturer of the industrial machine or the component creates the algorithm. In the other possible case, a third party creates the algorithm.

It is considered desirable that predictive maintenance of industrial machines be performed collectively on a production-factory-by-production-factory basis or production-line-by-production-line basis. That is, it is considered desirable to centrally manage algorithms and parameters used in predictive maintenance of a wide variety of industrial machines as in the test procedure in the invention described in Patent Literature 1, and enable execution of each algorithm on a common platform.

In some case, the parameter of each algorithm includes highly confidential information. It is therefore necessary to ensure confidentiality of each parameter so that the content of each parameter can be browsed from the corresponding algorithm alone without being browsed from the other algorithms.

The present invention has been made in view of the above, and an object is to obtain an information processing apparatus capable of performing predictive maintenance of industrial machines by managing and using a plurality of algorithms and parameters to be used in predictive maintenance of each of a plurality of industrial machines, keeping each parameter in confidence.

### Solution to Problem

In order to solve the above-described problems and to achieve the object, an information processing apparatus according to the present invention comprises: an algorithm block unit to store one or more algorithms to perform information processing related to predictive maintenance of an industrial machine and a component of the industrial machine; and a parameter block unit to store one or more parameters applicable to an algorithm stored in the algorithm block unit. The information processing apparatus also comprises: a diagnosis unit to perform information processing, using an algorithm selected by a user among algorithms stored in the algorithm block unit, and perform diagnosis of an industrial machine and a component of the industrial machine; and a first interface unit to read, from the parameter block unit, a parameter associated with the algorithm selected by a user and pass the parameter to the algorithm selected by a user.

### Advantageous Effects of Invention

The information processing apparatus according to the present invention exhibits an effect of being capable of performing predictive maintenance of industrial machines, by managing and using a plurality of algorithms and parameters to be used in predictive maintenance of each of a plurality of industrial machines, keeping each parameter in confidence.

### BRIEF DESCRIPTION OF DRAWINGS

FIG. 1 is a diagram illustrating an example configuration of an information processing apparatus according to an embodiment of the present invention.

FIG. 2 is a diagram illustrating an example of a predictive maintenance system implemented by applying the information processing apparatus according to the present invention.

FIG. 3 is a flowchart illustrating an example of an operation in which the information processing apparatus acquires an algorithm and a parameter.

FIG. 4 is a flowchart illustrating an example of an operation of diagnosing a diagnostic target by the information processing apparatus.

FIG. 5 is a diagram illustrating a first example of a relationship between the information processing apparatus and an industrial machine.

FIG. 6 is a diagram illustrating a second example of the relationship between the information processing apparatus and the industrial machine.

### DESCRIPTION OF EMBODIMENTS

An information processing apparatus according to an embodiment of the present invention will be hereinafter described in detail with reference to the drawings. It should be noted that the present invention is not limited by this embodiment.

### Embodiment

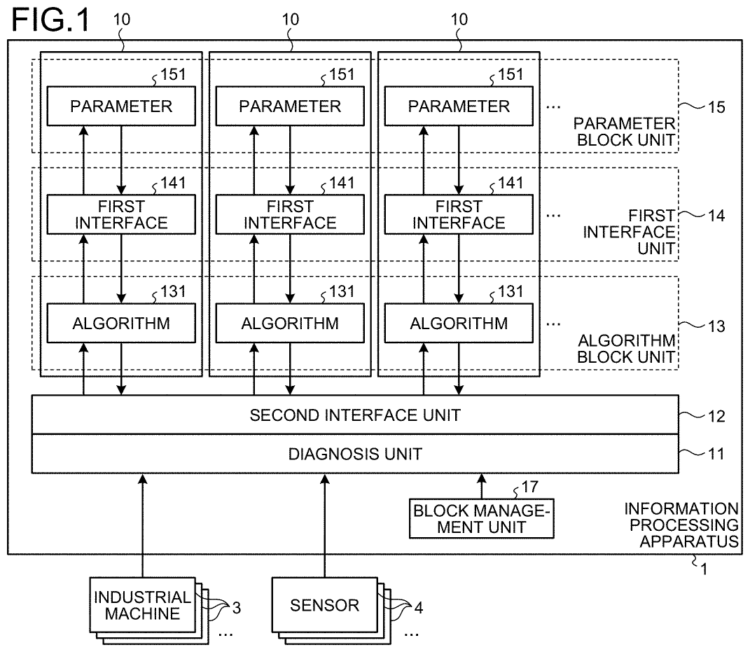

FIG. 1 is a diagram illustrating an example configuration of an information processing apparatus according to the embodiment of the present invention. An information processing apparatus 1 according to the present embodiment having the configuration illustrated in FIG. 1 performs information processing related to predictive maintenance of each of industrial machines 3 and a component (not illustrated) of each industrial machine 3. Specifically, the information processing apparatus 1 analyzes data collected from the industrial machines 3 and data collected from sensors 4, and diagnoses the industrial machines 3 and the components of the industrial machines 3. Note that each sensor 4 is attached to the component of the corresponding industrial machine 3. The data collected from the industrial machine 3 is, for example, information on an operation of the industrial machine 3. The industrial machines 3 are, for example, a semiconductor manufacturing device, a construction machine, an injection molding machine, a numerical control device, a servo motor, and a robot. The sensors 4 are, for example, a temperature sensor, a current sensor, a voltage sensor, an optical sensor, a vibration sensor, a sound sensor, and an image sensor.

The information processing apparatus 1 includes a diagnosis unit 11, a second interface unit 12, an algorithm block unit 13, a first interface unit 14, a parameter block unit 15, and a block management unit 17.

The algorithm block unit 13 holds an algorithm 131 that performs information processing related to predictive maintenance. The algorithm block unit 13 holds one or more algorithms 131. The parameter block unit 15 holds a parameter 151 applicable to the algorithm 131. The parameter block unit 15 holds one or more parameters 151. The first interface unit 14 includes one or more first interfaces 141. The first interface 141 reads, from the parameter block unit 15, the parameter 151 to be used by the algorithm 131 and passes the parameter 151 to the algorithm 131. The algorithms 131 held by the algorithm block unit 13 are associated with the parameters 151 held by the parameter block unit 15 in a one-to-one correspondence, and each algorithm 131 and the corresponding parameter 151 provide a single diagnostic module 10.

The diagnosis unit 11 diagnoses the industrial machine 3 or the component of the industrial machine 3 on the basis of data output from the industrial machine 3 and the sensor 4. Specifically, the diagnosis unit 11 performs the diagnosis by executing the algorithm 131 held by the algorithm block unit 13, and analyzing the data output from the industrial machine 3 and the sensor 4. That is, the diagnosis unit 11 passes the data output from the industrial machine 3 and the sensor 4, via the second interface unit 12 to the algorithm 131 corresponding to a diagnostic target. The diagnostic target is the industrial machine 3 or the component of the industrial machine 3. The diagnosis unit 11 then diagnoses the diagnostic target by having the algorithm 131 corresponding to the diagnostic target analyze the data. The algorithm 131 corresponding to the diagnostic target analyzes the data by using one of the parameters 151 held by the parameter block unit 15, which one parameter 151 is associated in advance with that algorithm 131. That is, the first interface 141 associated with the algorithm 131 corresponding to the diagnostic target reads, from the parameter block unit 15, the parameter 151 associated in advance, and passes the associated parameter 151 to the algorithm 131 corresponding to the diagnostic target. The second interface unit 12 passes, to the diagnosis unit 11, an analysis result provided by the algorithm 131 corresponding to the diagnostic target.

The block management unit 17 manages a correspondence relationship between each algorithm 131 held by the algorithm block unit 13 and each parameter 151 held by the parameter block unit 15.

In the information processing apparatus 1 according to the present embodiment, the parameter 151 used by each algorithm 131 of the algorithm block unit 13 is passed via the associated first interface 141 to that algorithm 131, and hence, each algorithm 131 cannot see the parameters 151 used by other algorithms 131. That is, providing the first interface unit 14 makes each parameter 151 accessible only from the corresponding algorithm 131, thereby achieving concealment of each parameter 151. In addition, as illustrated in FIG. 1, there is the second interface unit 12 between the diagnosis unit 11 and the algorithm block unit 13. That is, there are two interface units between the diagnosis unit 11 and each parameter 151, and the diagnosis unit 11 needs to cross the two interface units in order to access each parameter 151. Security of each parameter 151 can be therefore improved making it possible to prevent a parameter for achieving highly accurate diagnosis and know-how related to creation of this parameter from leaking to a third party.

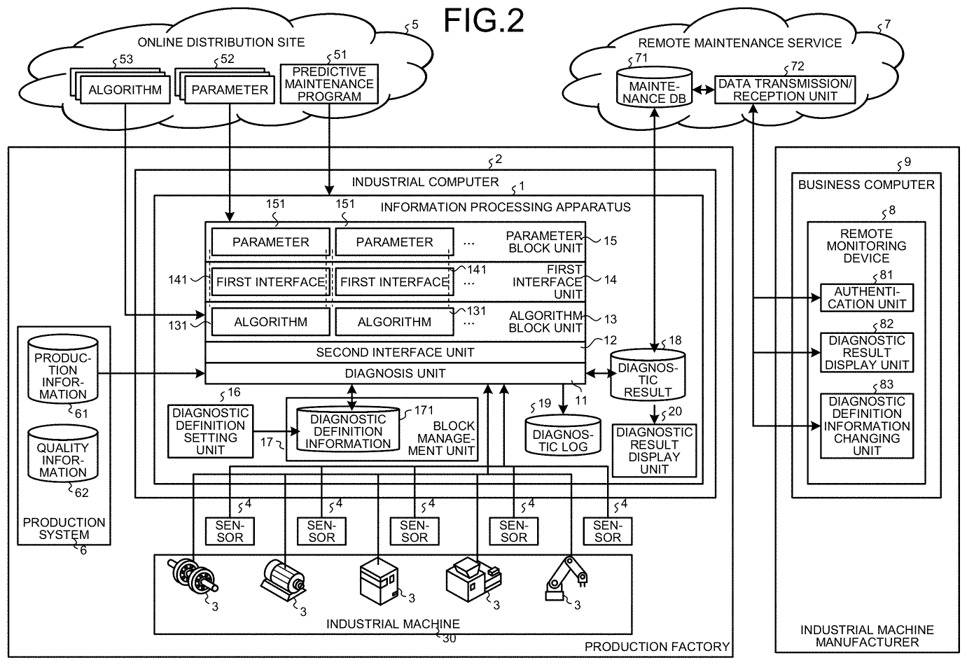

FIG. 2 is a diagram illustrating an example of a predictive maintenance system implemented by applying the information processing apparatus 1 according to the present invention. FIG. 2 illustrates, in more detail, the configuration of the information processing apparatus 1 also illustrated in FIG. 1. Hereinafter, d Details of the information processing apparatus 1 and details of a predictive maintenance system will be hereinafter described with reference to FIG. 2.

As illustrated in FIG. 2, in addition to individual constituent elements illustrated in FIG. 1, the information processing apparatus 1 includes a diagnostic definition setting unit 16 and a diagnostic result display unit 20. The diagnostic definition setting unit 16 receives an input of diagnostic definition information 171 held by the block management unit 17, and stores the input in the block management unit 17. The diagnostic result display unit 20 displays a diagnostic result 18 obtained by the diagnosis unit 11 diagnosing a diagnostic target. The diagnostic definition information 171 includes information indicating a correspondence relationship between each algorithm 131 held by the algorithm block unit 13 and each parameter 151 held by the parameter block unit 15.

Note that the diagnostic result display unit 20 may be configured to exist outside the information processing apparatus 1. In addition, the diagnostic result 18 is displayed on the diagnostic result display unit 20, and is also stored in a maintenance database (DB) 71 of a remote maintenance service 7. The remote maintenance service 7 collects and manages a diagnostic result of an industrial machine and a diagnostic result of the component of the industrial machine from a device similar to the information processing apparatus 1, manages these diagnostic results, and provides the diagnostic results to a device that requires the diagnostic result. The remote maintenance service 7 includes a data transmission/reception unit 72 that transmits and receives data to and from the device that requires the diagnostic result. An example of the device that requires the diagnostic result is an illustrated remote monitoring device 8. The remote monitoring device 8 is implemented by a business computer 9 of an industrial machine manufacturer. That is, the business computer 9 executes a program for operating as the remote monitoring device 8, thereby implementing the remote monitoring device 8. The remote monitoring device 8 provides a function of causing a user to examine the diagnostic result 18 generated by the information processing apparatus 1, and a function of causing the user to change the diagnostic definition information 171 held by the block management unit 17 of the information processing apparatus 1. The remote monitoring device 8 includes an authentication unit 81, a diagnostic result display unit 82, and a diagnostic definition information changing unit 83. The authentication unit 81 performs user authentication. The diagnostic result display unit 82 displays the diagnostic result 18 held by the maintenance DB 71 of the remote maintenance service 7. The diagnostic definition information changing unit 83 changes the diagnostic definition information 171 held by the block management unit 17 of the information processing apparatus 1. The diagnostic definition information changing unit 83 changes the diagnostic definition information 171 via the remote maintenance service 7.

The information processing apparatus 1 is implemented by an industrial computer 2 executing a program for operating as the information processing apparatus 1. That is, the program for operating as the information processing apparatus 1 is installed in the industrial computer 2, and the industrial computer 2 executes the program to thereby implement the information processing apparatus 1. An example of the program for operating as the information processing apparatus 1 is a predictive maintenance program 51 distributed from an online distribution site 5. As described above, the information processing apparatus 1 can be implemented by the industrial computer 2 and the predictive maintenance program 51. Note that, instead of downloading and acquiring the predictive maintenance program 51 from the online distribution site 5, the industrial computer 2 may read and acquire the predictive maintenance program 51 from a storage medium storing the predictive maintenance program 51.

The diagnostic definition setting unit 16 receives an user's operation for setting the diagnostic definition information 171 held by the block management unit 17, and generates the diagnostic definition information 171 in accordance with content of the received operation and stores the generated diagnostic definition information in the block management unit 17. When receiving an operation for setting the diagnostic definition information 171 with the diagnostic definition information 171 stored in the block management unit 17, the diagnostic definition setting unit 16 updates the diagnostic definition information 171 stored in the block management unit 17, in accordance with the content of the received operation.

Specifically, the diagnostic definition setting unit 16 first receives information on the algorithm 131 stored in the algorithm block unit 13 and information on the parameter 151 stored in the parameter block unit 15 via the diagnosis unit 11. The diagnostic definition setting unit 16 then displays a list of the algorithms 131 and a list of the parameters 151 on a display unit (not illustrated) to notify the user of these lists. Next, the diagnostic definition setting unit 16 receives, from the user, an operation of setting the algorithm 131 and the parameter 151 to be used in diagnosing the diagnostic target on the basis of data acquired from the industrial machine 3 and the sensor 4, a timing at which to perform the diagnosis, data to be used for the diagnosis, and the like. The diagnostic definition setting unit 16 generates the diagnostic definition information 171 in accordance with a content of the received operation and stores the generated diagnostic definition information 171 in the block management unit 17. Depending on the algorithm 131 to be used, the diagnostic definition setting unit 16 receives an operation of setting production information 61 held by a production system 6, in data to be used for diagnosis, in addition to receiving the data from the sensor 4 and the data from the industrial machine 3. The production information 61 includes various types of information related to production of a product, such as a production plan to produce a product using an industrial machine group 30, a production performance, and a work procedure. Note that, although the production system 6, and each industrial machine 3 and each sensor 4 are separately illustrated in FIG. 2 for convenience, each industrial machine 3 and each sensor 4 are practically included in the production system 6. The information held by the production system 6 also includes quality information 62 on the product. The diagnosis unit 11 may use the quality information 62 at the time of diagnosis in some cases.

Each algorithm 131 held by the algorithm block unit 13 is selected and downloaded from individual algorithms 53 held by the online distribution site 5. The algorithm 53 to be downloaded is selected by the user before the diagnostic definition setting unit 16 generates the diagnostic definition information 171. Note that, the algorithm block unit 13 may download the necessary algorithm 53 from the online distribution site 5 when the diagnostic definition setting unit 16 generates the diagnostic definition information 171.

A diagnosis execution command directed to each algorithm 131 held by the algorithm block unit 13 is issued from the diagnosis unit 11 via the second interface unit 12. Given that data items to be received from and transmitted to the second interface unit 12 are standardized, a developer of the manufacturer of each algorithm 131 creates the algorithm 131 corresponding to the second interface unit 12, thereby making it possible for the information processing apparatus 1 to operate the algorithms 131 manufactured by different manufacturers.

The parameter 151 which the algorithm 131 uses in performing s diagnosis processing on the diagnostic target includes information such as a model and an operation pattern of the diagnostic target. The algorithm 131 uses the dedicated parameter 151 associated therewith to thereby perform detailed diagnosis processing according to the model and the operation pattern of the diagnostic target. Each parameter 151 is encrypted in such a manner that only the associated algorithm 131 can refer to that parameter 151 via the first interface 141. That is, the first interface unit 14 sets the first interface 141 through which each algorithm 131 stored in the algorithm block unit 13 can refer to the dedicated parameter 151 associated with that algorithm, but cannot refer to the parameters 151 associated with the other algorithms 131. This allows the information processing apparatus 1 to execute each algorithm 131 in an environment in which algorithms 131 of a plurality of manufacturers, keeping each parameter 151 in confidence.

Each algorithm 131 executes diagnosis in accordance with an instruction from the diagnosis unit 11. On the basis of input data from the industrial machine 3 and the sensor 4 and the diagnostic definition information 171, the diagnosis unit 11 calls the algorithm 131 corresponding to the input data, and executes diagnosis. The diagnosis unit 11 is a software platform. When the diagnosis by the algorithm 131 ends, the diagnosis unit 11 outputs the diagnostic result 18 to the diagnostic result display unit 20 and the maintenance DB 71 of the remote maintenance service 7. The user can know a state of the diagnostic target by checking the diagnostic result 18 displayed on the diagnostic result display unit 20. The diagnostic result 18 output to the maintenance DB 71 is managed on a diagnostic-target-by-diagnostic target basis.

Note that the algorithm 131 can periodically perform diagnosis at a timing designated in advance. Alternatively, the algorithm 131 can perform diagnosis in accordance with an execution request made by the outside such as the industrial machine 3.

The diagnosis unit 11 outputs the diagnostic result 18 in a standardized common output format regardless of the algorithm 131 that performs diagnosis. Even when diagnosis is performed by the algorithms 131 developed by different manufacturers, therefore, the user can refer to the diagnostic result 18 in an identical format.

Further, when any error occurs during diagnosis processing performed by the algorithm 131, an error code is output to a diagnostic log 19 via the diagnosis unit 11. The error code defines a code common to individual algorithms 131 and a unique code of each algorithm 131. When an error occurs, thus, it is easy to investigate a cause of the error and take necessary measures. Further, the error code defines a query destination corresponding to the error code, such that follow-through support can be easily performed.

Each parameter 151 held by the parameter block unit 15 is selected and downloaded from individual parameters 52 held by the online distribution site 5. Similarly to each algorithm 131 held by the algorithm block unit 13, the parameter 52 to be downloaded is selected by the user before the diagnostic definition setting unit 16 generates the diagnostic definition information 171. The parameter block unit 15 may download the necessary parameter 52 from the online distribution site 5 when the diagnostic definition setting unit 16 generates the diagnostic definition information 171.

Note that the predictive maintenance program 51, the parameter 52, and the algorithm 53 uploaded to the online distribution site 5 are updated as appropriate. The industrial computer 2 downloads some or all of the predictive maintenance program 51, the parameter 52, and the algorithm 53 in accordance with an instruction from the user. The information processing apparatus 1 does not need to update the diagnostic definition information 171 even in a case where the parameter 52 is downloaded and the parameter 151 stored in the parameter block unit 15 is updated, or the algorithm 53 is downloaded and the algorithm 131 stored in the algorithm block unit 13 is updated. That is, a correspondence relationship between each algorithm 131 stored in the algorithm block unit 13 and each parameter 151 stored in the parameter block unit 15 is maintained even when some or all of the algorithms 131 and parameters 151 are updated. In other words, the algorithm block unit 13 and the parameter block unit 15 are configured to be capable of updating each algorithm 131 and each parameter 151, maintaining the relationship between each algorithm 131 and each parameter 151 that are stored. Note that, the above-described embodiment is made giving an example where the diagnostic definition information 171 is not updated. However, in a case where the diagnostic definition information 171 is downloaded from an online site and updated, contents set therein are changed depending on the update contents. For example, when a new option can be designated by addition of an algorithm function, the diagnostic definition information 171 is updated.

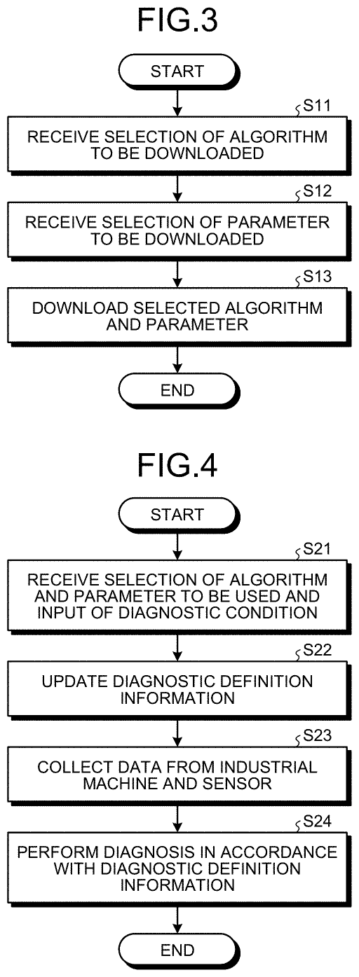

FIG. 3 is a flowchart illustrating an example of an operation in which the information processing apparatus 1 acquires the algorithm 131 and the parameter 151.

Before starting the operation of diagnosing the diagnostic target, the information processing apparatus 1 acquires the necessary algorithm 131 and parameter 151 from the online distribution site 5 in accordance with a procedure illustrated in FIG. 3. Note that, the present embodiment is described giving an example of acquiring the algorithm 131 and the parameter 151 from the online distribution site 5. However, the necessary algorithm 131 and parameter 151 may be acquired directly from a seller rather than the online distribution site 5.

First, the information processing apparatus 1 receives, from the user, selection of the algorithm 53 to be downloaded from among the algorithms 53 held by the online distribution site 5 (step S11). Next, the information processing apparatus 1 receives, from the user, selection of the parameter 52 to be downloaded from among the parameters 52 held by the online distribution site 5 (step S12). Next, the information processing apparatus 1 downloads, from the online distribution site 5, the algorithm 53 and the parameter 52 selected by the user, (step S13). The information processing apparatus 1 stores the downloaded algorithm 53 as the algorithm 131 in the algorithm block unit 13, and stores the downloaded parameter 52 as the parameter 151 in the parameter block unit 15.

FIG. 4 is a flowchart illustrating an example of an operation in which the information processing apparatus 1 diagnoses a diagnostic target.

After completing the acquisition of the algorithm 131 and the parameter 151 by executing the operation illustrated in FIG. 3, the information processing apparatus 1 executes the operation illustrated in FIG. 4 to diagnose the diagnostic target.

First, the information processing apparatus 1 receives, from the user, selection of the algorithm 131 and the parameter 151 to be used in diagnosis, and input of a diagnostic condition (step S21). For the input of the diagnostic condition, the information processing apparatus 1 receives, for example, designation of a condition for starting diagnosis or a timing at which to perform the diagnosis by using the algorithm 131 and the parameter 151 selected by the user, and designation of data to be used in the diagnosis. In addition, in receiving the selection of the algorithm 131 and the parameter 151 to be used in diagnosis, the information processing apparatus 1 notifies the user of a list of the algorithms 131 stored in the algorithm block unit 13 and a list of the parameters 151 stored in the parameter block unit 15 by displaying these lists on a notification unit (not illustrated), for example. In step S21, the information processing apparatus 1 allows the user to select a single algorithm 131 and a single parameter 151.

When the user selects the algorithm 131 and the parameter 151 to be used in the diagnosis, and inputs the diagnostic condition, the information processing apparatus 1 updates the diagnostic definition information 171 on the basis of results of the selection of the algorithm 131 and the parameter 151 and the input diagnostic condition (step S22). Specifically, the diagnostic definition setting unit 16 generates information indicating that the algorithm 131 and the parameter 151 selected in step S21 correspond to the input diagnostic condition, and adds the generated information to the diagnostic definition information 171.

Note that, when there are a plurality of diagnostic targets, the information processing apparatus 1 repeatedly executes steps S21 and S22 described above, generates, for each of the plurality of diagnostic targets, information indicating that the algorithm 131 and the parameter 151 to be used correspond to the diagnostic condition, and adds the generated information to the diagnostic definition information 171.

After updating the diagnostic definition information 171 in step S22, the information processing apparatus 1 collects data from the industrial machine 3 and the sensor 4 (step S23), and diagnoses the diagnostic target in accordance with the diagnostic definition information 171 (step S24). Specifically, when a diagnosis execution timing of the diagnostic definition information 171 comes or a diagnosis start condition of the diagnostic definition information 171 is satisfied, the diagnosis unit 11 performs diagnosis of the diagnostic target, using the corresponding algorithm 131 and parameter 151 and data acquired from the industrial machine 3 and the sensor 4.

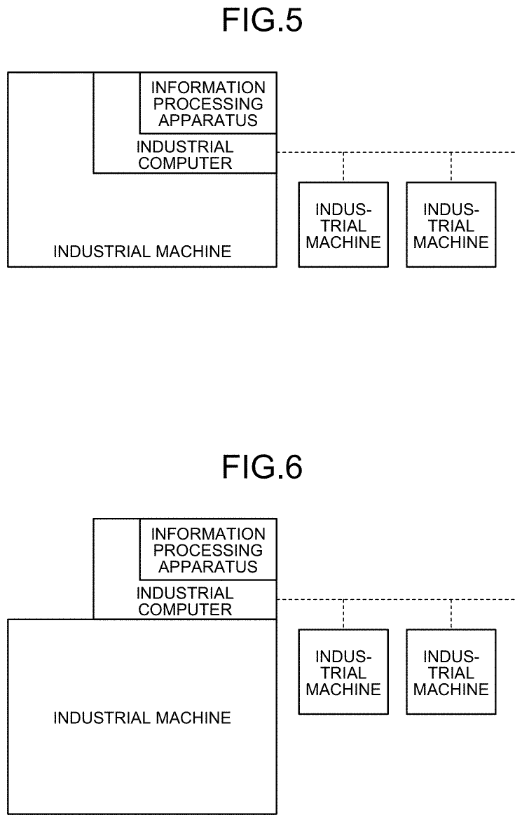

Note that, FIGS. 1 and 2 illustrate an example where the information processing apparatus 1 and the industrial machines 3 exist at a distant position from each other and are connected by a network, but a configuration illustrated in FIGS. 5 and 6 may be adopted. That is, as in a first example illustrated in FIG. 5, an industrial computer incorporated in the industrial machine 3 may be used. This configuration of FIG. 5 is advantageous because the configuration can be made without the need to add hardware and a network to the industrial machine 3. In addition, a configuration as in a second example illustrated in FIG. 6, in which the information processing apparatus 1 is externally attached to one industrial machine 3, provides advantage that the information processing apparatus 1 can be retrofitted to the already operating industrial machine 3.

As described above, the information processing apparatus 1 according to the present embodiment includes: the algorithm block unit 13 that stores the algorithm 131 that performs information processing related to predictive maintenance; the parameter block unit 15 that stores the parameter 151 to be used by the algorithm 131 stored in the algorithm block unit 13; the diagnosis unit 11 that performs information processing related to predictive maintenance, using the algorithm 131 selected by the user among the algorithms 131 stored in the algorithm block unit 13 and diagnoses the industrial machine 3 or the component of the industrial machine 3; and the first interface unit 14 that reads, from the parameter block unit 15, the parameter 151 associated with the algorithm 131 selected by the user and passes the parameter 151 to the algorithm 131. The information processing apparatus 1 of the present embodiment can perform predictive maintenance of the industrial machine 3 and the component of the industrial machine 3 by managing and using the plurality of algorithms 131 and parameters 151 to be used in predictive maintenance of each of the plurality of industrial machines 3, keeping each parameter 151 in confidence.

The configuration illustrated in the above embodiment illustrates one example of the contents of the present invention and can be combined with another known technique, and it is also possible to omit and change a part of the configuration without departing from the subject matter of the present invention.

### REFERENCE SIGNS LIST

1 information processing apparatus; 2 industrial computer; 3 industrial machine; 4 sensor; 5 online distribution site; 6 production system; 7 remote maintenance service; 8 remote monitoring device; 9 business computer; 10 diagnostic module; 11 diagnosis unit; 12 second interface unit; 13 algorithm block unit; 14 first interface unit; 15 parameter block unit; 16 diagnostic definition setting unit; 17 block management unit; 18 diagnostic result; 19 diagnostic log; 20, 82 diagnostic result display unit; 30 industrial machine group; 51 predictive maintenance program; 52, 151 parameter; 53, 131 algorithm; 61 production information; 62 quality information; 71 maintenance database; 72 data transmission/reception unit; 81 authentication unit; 83 diagnostic definition information changing unit; 141 first interface; 171 diagnostic definition information.

1. An information processing apparatus implemented by a computer and a program installed in the computer, the computer executing the program to perform:
an algorithm storage process of storing one or more algorithms to perform information processing related to predictive maintenance of an industrial machine and a component of the industrial machine;
a parameter storage process of storing one or more parameters applicable to an algorithm stored by the algorithm storage process;
a diagnosis process of performing information processing, using an algorithm selected by a user among algorithms stored by the algorithm storage process, and performing diagnosis of an industrial machine and a component of the industrial machine; and
a first interface process of reading, from the parameter block unit, a parameter associated with the algorithm selected by a user, and passing the parameter to the algorithm selected by a user.

2. The information processing apparatus according to claim 1, wherein the computer executes the program to further perform
a block management process of holding diagnostic definition information including information on a correspondence relationship between each algorithm stored by the algorithm storage process and each parameter stored by the parameter storage process, wherein
on a basis of the diagnostic definition information, the first interface process passes a parameter stored in the parameter block unit to an algorithm stored in the algorithm block unit.

3. The information processing apparatus according to claim 1, wherein
a parameter stored by the parameter storage process is encrypted.

4. The information processing apparatus according to claim 1, wherein
the algorithm storage process and the parameter storage process are capable of updating each stored algorithm and each stored parameter, maintaining a correspondence relationship between each stored algorithm and each stored parameter.

5. The information processing apparatus according to claim 1, wherein the computer executes the program to further perform
a second interface to: pass data for use in the diagnosis, to a corresponding algorithm stored by the algorithm storage process, the data being collected by the diagnosis process; and provide, for the diagnosis process, a result of information processing that the corresponding algorithm stored by the algorithm storage process performs using the data.

6. The information processing apparatus according to claim 5, wherein
a plurality of the algorithms is connected to the second interface.

7. The information processing apparatus according to claim 1, wherein
an algorithm to be stored by the algorithm storage process and a parameter to be stored by the parameter storage process are acquired from an online distribution site.
